(19) United States
(12) Patent Application Publication
(10) Pub. No.: US 2024/0202585 A1
(43) Pub. Date: Jun. 20, 2024

(54) MACHINE LEARNING FAILURE RECOVERY APPARATUS AND CONTROL METHOD THEREOF

(71) Applicant: STRATO CO., LTD., Seoul (KR)

(72) Inventors: Hyeong-Doo KIM, Yongin-si (KR); Ho-Chul LEE, Suwon-si (KR); Sun-Kyu PARK, Seoul (KR); Nam-Kyu PARK, Seoul (KR); Yong-Min KWON, Bucheon-si (KR)

(73) Assignee: STRATO CO., LTD., Seoul (KR)

(21) Appl. No.: 18/211,912

(22) Filed: Jun. 20, 2023

Related U.S. Application Data
(63) Continuation of application No. PCT/KR2022/020371, filed on Dec. 14, 2022.

(51) Int. Cl. G06N 20/00; G06F 11/14

(52) U.S. Cl. CPC G06N 20/00; G06F 11/1458

(57) ABSTRACT

A machine learning failure recovery apparatus and control method thereof are provided. The control method of a machine learning failure recovery apparatus according to the present invention t may include performing machine learning with learning data as an input, wherein the machine learning includes matching a learning data location where a learning has been completed with an intermediate storage model whenever a preset backup time arrives and storing a result of the matching; determining whether a failure occurs during the machine learning; extracting the intermediate storage model closest to a point in time when the failure occurred and a position of the learning data matched with the corresponding intermediate storage model when it is determined that the failure occurred; and resuming machine learning based on the extracted intermediate storage model and location of the learning data.

### CROSS-REFERENCE TO RELATED APPLICATIONS

This application is a bypass continuation of International Application No. PCT/KR2022/020371, filed Dec. 14, 2022 in the Korean Intellectual Property Office. All disclosures of the document named above are incorporated herein by reference.

### Technical Field

The present invention relates to a machine learning failure recovery apparatus and a control method thereof, and more particularly, to an apparatus for recovering a learning model when a failure occurs during machine learning and control method thereof.

For reference, the present invention is derived through a project supported by the Ministry of Science and ICT, and the task-related information is as follows.

Assignment ID number: 1711134459, Assignment number: 2021-0-00281, Ministry name: Ministry of Science and ICT, Institutions specializing in research management: National Institute of Information and Communications Technology Planning and Evaluation; Research project name: SW computing industry original technology development (R&D, Informatization), Title of research project: ‘Development of high-density operator resource placement optimization technology to maximize the performance efficiency of high-load complex machine learning workloads in a hybrid cloud environment’, Contribution rate: 1/1; Organizer: Strato Co., Ltd., Research period: 2022.01.01˜2022.12.31.

### BACKGROUND ART

There is an increasing demand for the use of machine learning models for artificial intelligence services in various industries.

In many artificial intelligence service industries, artificial intelligence service models have been created using machine learning open source platforms, and it is necessary to continuously improve and maintain the models to satisfy the requirements of these artificial intelligence industries.

For this, a lot of resources are used and costs are also incurred. When a failure occurs while learning an artificial intelligence model through machine learning, many resources have to be reused from the beginning.

In general, storage and the like are provided with functions for performing error recovery when a failure occurs, but the process of machine learning is completely different from this storage recovery process, so when a failure occurs during learning, the learning itself must be restarted from the beginning.

For example, when a failure occurs during machine learning using the 50,000th training data while loading 100,000 training data and executing machine learning, after recovering from the failure, machine learning has to be loaded with 100,000 training data from the beginning to proceed with machine learning.

However, as described above, machine learning requires a fairly large amount of IT resources.

In this way, when a failure occurs in a workload during machine learning, it is highly undesirable in terms of time and cost to perform the process again from the beginning.

### PRIOR ART DOCUMENT

Korean Patent Publication No. 10-2021-0138502

### DISCLOSURE

### Technical Problem

The present invention has been made to solve the above conventional problems, and an object of the present invention is to provide a machine learning failure recovery apparatus and a control method thereof in order to reduce processing time and minimize resource usage when machine learning resumes later when a failure occurs in a machine learning workload.

### Technical Solution

In order to achieve the above object, a control method of a machine learning failure recovery apparatus according to the present invention t may include performing machine learning with learning data as an input, wherein the machine learning includes matching a learning data location where a learning has been completed with an intermediate storage model whenever a preset backup time arrives and storing a result of the matching; determining whether a failure occurs during the machine learning; extracting the intermediate storage model closest to a point in time when the failure occurred and a position of the learning data matched with the corresponding intermediate storage model when it is determined that the failure occurred; and resuming machine learning based on the extracted intermediate storage model and location of the learning data.

Here, the control method of a machine learning failure recovery apparatus may further include matching the intermediate storage model with the location of the learning data at a preset backup time interval and storing a result of the matching, and changing a size of the backup time interval based on at least one of a type of learning data, an amount of remaining learning data, and a type and shape of a machine learning model.

Here, the control method of a machine learning failure recovery apparatus may further include matching the intermediate storage model with the location of the learning data at a preset backup time interval and storing a result of the matching, and dynamically changing a size of the backup time interval based on a machine learning elapsed time point at which an error occurred during machine learning by the learning progress unit.

Here, the control method of a machine learning failure recovery apparatus may further include matching the intermediate storage model with the location of the learning data at a preset backup time interval and storing a result of the matching, and dynamically changing a size of the backup time interval based on a time interval in which a failure occurs during machine learning by the learning progress unit.

Here, the control method of a machine learning failure recovery apparatus may further include matching the intermediate storage model with the location of the learning data at a preset backup time interval and storing a result of the matching, and dynamically changing a size of the backup time interval based on the type and cause of the identified failure after confirming the type and cause of the failure through log records, when a failure occurs during machine learning by the learning progress unit.

Also, in order to achieve the above object, a machine learning failure recovery apparatus according to the present invention may include a learning progress unit that performs machine learning using learning data as an input, wherein the machine learning includes matching an intermediate storage model with the location of the learning data that has been learned whenever a preset backup time arrives and storing a result of the matching; determination unit that determines whether a failure occurs during machine learning by the learning progress unit; and an extraction unit for extracting the intermediate storage model closest to a point in time when the failure occurs and a location of learning data matched with the corresponding intermediate storage model when the determination unit determines that a failure occurs, wherein the learning progress unit resumes machine learning based on the intermediate storage model and the location of the learning data extracted by the extraction unit.

Here, the learning progress unit may match the intermediate storage model with the location of the learning data at a preset backup time interval and store a result of the matching, and the machine learning failure recovery apparatus may further include a backup time adjustment unit that changes a size of the backup time interval based on at least one of a type of learning data, an amount of remaining learning data, and a type and shape of a machine learning model.

Here, the learning progress unit may match the intermediate storage model with the location of the learning data at a preset backup time interval and store a result of the matching, and the machine learning failure recovery apparatus may further include a backup time adjustment unit that dynamically changes a size of the backup time interval based on a machine learning elapsed time point at which an error occurred during machine learning by the learning progress unit.

Here, the learning progress unit may match the intermediate storage model with the location of the learning data at a preset backup time interval and store a result of the matching, and the machine learning failure recovery apparatus may further include a backup time adjustment unit that dynamically changes a size of the backup time interval based on a time interval in which a failure occurs during machine learning by the learning progress unit.

Here, the learning progress unit may match the intermediate storage model with the location of the learning data at a preset backup time interval and store a result of the matching, and the machine learning failure recovery apparatus may further include a backup time adjustment unit that dynamically changes a size of the backup time interval based on the type and cause of the identified failure after confirming the type and cause of the failure through log records, when a failure occurs during machine learning by the learning progress unit.

### DESCRIPTION OF DRAWINGS

FIG. 1 is a functional block diagram of an apparatus for recovering machine learning failure according to an embodiment of the present invention, and

FIG. 2 is a control flow diagram of an apparatus for recovering machine learning failure according to an embodiment of the present invention.

### BEST MODE

Hereinafter, the present invention is described in detail with reference to the accompanying drawings.

Hereinafter, each embodiment according to the present invention is only one example to help understanding of the present invention, and the present invention is not limited to these embodiments. In particular, the present invention may be composed of at least one combinations of individual components, individual functions, or individual steps included in each embodiment.

In particular, for convenience, some claims include alphabets such as ‘(a)’, but these alphabets do not prescribe the order of each step.

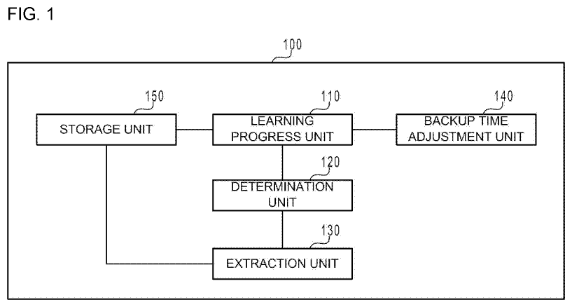

An example of a functional block of an apparatus 100 for recovering machine learning failure according to an embodiment of the present invention is shown in FIG. 1.

As shown in the drawings, the machine learning failure recovery apparatus 100 may include a learning progress unit 110, a determination unit 120, an extraction unit 130, a backup time adjustment unit 140, and a storage unit 150.

First of all, data, information, and applications necessary for the operation of the machine learning failure recovery apparatus 100 according to an embodiment of the present invention are stored in the storage unit 150, and furthermore, Furthermore, the storage unit 150 provides a space in which data, machine learning models, and the like generated during the operation of the machine learning failure recovery apparatus 100 are stored.

That is, the storage unit 150 stores data used by each component described below and new data generated during the operation of each component.

Preferably, the storage unit 150 is at least partially composed of a non-volatile memory in which stored data is retained even when power is cut off.

The learning progress unit 110 performs a function of performing machine learning by taking learning data as an input.

Here, the machine learning may perform various types of machine learning, such as supervised learning and unsupervised learning.

For reference, the supervised learning is literally learning data by using data with correct answers, and is, for example, a learning method that provides pictures of people and animals and informs people or animals as the correct answer.

Unlike the supervised learning, the unsupervised learning predicts results for new data by clustering data without correct labels with similar features.

Because this machine learning method and its processing process correspond to well-known technologies, a detailed description thereof is omitted.

In addition, the learning progress unit 110 also performs a function of matching and storing an intermediate storage model with the location of learning data that has been learned whenever a preset backup time arrives.

That is, the learning progress unit 110 matches a model (hereinafter, referred to as ‘intermediate storage model’) generated by learning until then in the middle of machine learning with the location of learning data that has been learned until then and stores a result of the matching.

For example, when learning is performed up to the 5,500th learning data among 10,000 learning data and the first intermediate storage model is generated, the learning progress unit 110 matches the first intermediate storage model with a kind of indexing information of 5,500 and stores a result of the matching.

The ‘backup time’, which is the basis for determining the timing of storing the intermediate storage model in the learning progress unit 110 may be specific time information or may be time information determined by a predetermined time interval, but intervals between adjacent backup times may not be the same.

For example, the learning progress unit 110 may store intermediate storage models and the like at 30-minute intervals.

Based on this process, a plurality of intermediate storage models may be stored until machine learning is finished.

Of course, only the intermediate storage model generated last may be left. However, because the most suitable one among a plurality of intermediate storage models may be used due to reasons, such as imbalance of learning data, the learning progress unit 110 may manage the plurality of intermediate storage models while they are stored.

On the other hand, when the learning progress unit 110 matches the intermediate storage model with the location of the learning data at a preset backup time interval and stores a result of the matching, the backup time interval may be set or dynamically changed for various reasons, and the backup time adjustment unit 140 performs this function, which is described in detail below.

The determination unit 120 performs a function of determining whether a failure occurs during machine learning by the learning progress unit 110.

That is, the determination unit 120 determines whether or not machine learning does not proceed normally due to a failure in the workload in which machine learning is being performed.

When the determination unit 120 determines that a failure occurs, the extraction unit 130 performs a function of extracting an intermediate storage model closest to the time point when the failure occurs and a location of the training data matched to the corresponding intermediate storage model.

In this way, when an intermediate storage model or the like is extracted by the extraction unit 130, the learning progress unit 110 described above resumes machine learning based on the intermediate storage model and the location of the training data.

For example, when the location of the training data matched to the extracted intermediate storage model is 5,500, the learning progress unit 110 may proceed with machine learning by inputting learning data from the 5,501th learning data to the corresponding intermediate storage model.

In this case, the learning progress unit 110 may delete an already existing machine learning model because the already existing machine learning model is in a damaged state due to the occurrence of a failure.

On the other hand, the backup time adjustment unit 140 performs a function of setting or dynamically changing the backup time or backup time interval used by the learning progress unit 110 based on various conditions.

For example, the backup time adjustment unit 140 may change the size of the backup time interval based on at least one of the type of learning data, the amount of remaining learning data, and the type and shape of the machine learning model.

In a specific system, because various failures may occur on the workload during machine learning for a specific machine learning model for a large amount of specific type of training data, the backup time adjustment unit 140 may set or dynamically change the backup time interval based on the various variables.

Because failure occurrence cases may be analyzed by a statistical approach, which may be achieved by collecting and analyzing a considerable amount of machine learning workload failure cases.

That is, although it is impossible to predict the possibility of machine learning workload failure with only one variable, there may be cases where the possibility of machine learning workload failure increases due to a combination of several variables. And thus, the backup time adjustment unit 140 may set an optimal backup time interval through statistical analysis using the type of learning data, the amount of remaining learning data, and the type of machine learning model.

In particular, in the initial stage of machine learning, workload failures may occur due to various unverified causes, so reduce the size of the backup time interval. Then, when a significant amount of machine learning progress has been made, the system is stabilized and furthermore, there is not much data left to learn, so the size of the backup time interval may be increased.

As another example, the backup time adjustment unit 140 may dynamically change the size of the backup time interval based on the machine learning elapsed time when a failure occurred during machine learning by the learning progress unit 110.

For example, with the backup time interval is set to a fixed time interval, when a failure occurs in the machine learning workload, a backup time interval shorter than the preset time interval may be set until a preset time elapses from the point in time when the failure occurred.

This is to save an intermediate storage model at a shorter time interval, because similar failures may occur repeatedly when a failure occurs once, until the cause is accurately analyzed.

As another example, the backup time adjustment unit 140 may dynamically change the size of the backup time interval based on the time interval in which a failure occurs during machine learning by the learning progress unit 110.

For example, in the case where failure occurs several times, when the failure occurrence interval is short, a shorter backup time interval is provided in proportion to the failure occurrence interval, and when the failure occurrence interval is long, a backup time interval is made proportionally longer.

Furthermore, when a failure occurs during machine learning by the learning progress unit 110, after confirming the type and cause of the corresponding failure through log records, the backup time adjustment unit 140 may dynamically change the size of the backup time interval based on the identified type and cause of the failure.

For example, when the type of failure is an external one-time cause, such as forced power off, there is no need to reduce the size of the backup time interval, but when the type of failure is an internal cause, such as system memory/cpu overload, it is necessary to reduce the size of the backup time interval.

In this case, the backup time adjustment unit 140 may change the size of the backup time interval in consideration of the failure type and cause occurrence pattern.

For example, when memory usage continuously increases as machine learning progresses or when a failure occurs due to an excess of memory capacity, the backup time adjustment unit 140 preferably reduces the size of the backup time interval.

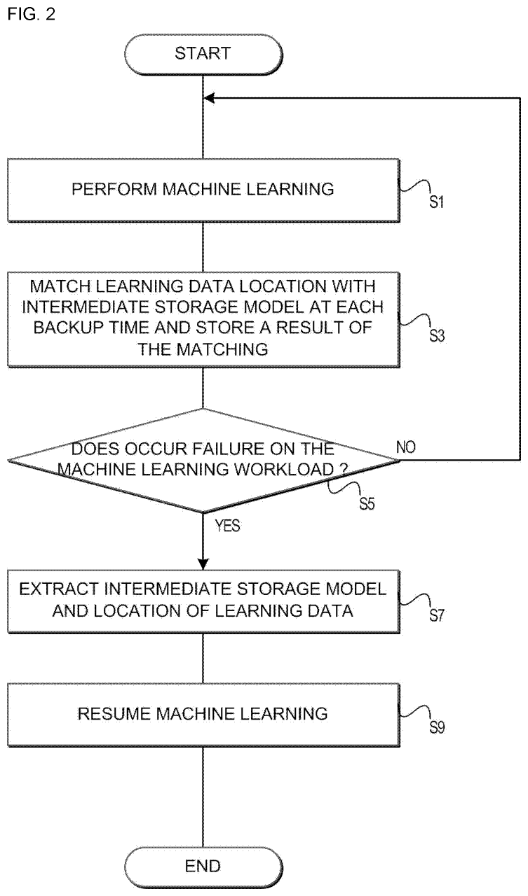

Hereinafter, the overall control flow of the machine learning failure recovery apparatus 100 according to an embodiment of the present invention is described with reference to FIG. 2.

First, the machine learning failure recovery apparatus 100 performs machine learning using pre-stored training data (step S1).

In this case, the machine learning failure recovery apparatus 100 matches the learning data location with intermediate storage model at each preset backup time and stores a result of the matching.

Here, the backup time may be dynamically changed depending on a predetermined situation.

For example, the machine learning failure recovery apparatus 100 may change the size of the backup time interval based on at least one of the type of training data, the amount of remaining training data, and the type and shape of the machine learning model, and as is described below, the machine learning failure recovery apparatus 100 may change the size of the backup time interval based on various information related to the point in time when the failure occurred.

For example, the size of the backup time interval may be dynamically changed based on the elapsed time of machine learning after a failure occurred during machine learning by the learning progress unit and the time interval at which a failure occurred.

In particular, the machine learning failure recovery apparatus 100 may dynamically change the size of the backup time interval based on the type and cause of the confirmed failure.

In this way, when a failure occurs on the machine learning workload while machine learning is in progress (step S5), the machine learning failure recovery apparatus 100 extracts a pre-stored intermediate storage model and a location of learning data matched thereto (step S7).

Thereafter, the machine learning failure recovery apparatus 100 resumes machine learning using the extracted intermediate storage model and the location of the learning data (step S9).

Therefore, because machine learning only needs to be additionally performed on the data from the time the intermediate storage model is saved to the time the actual failure occurs, damage caused by failure may be minimized.

On the other hand, of course, the process of performing each of the above-described embodiments may be performed by a program or application stored in a predetermined recording medium (for example, computer-readable). Here, the recording medium includes all of an electronic recording medium, such as random access memory (RAM), a magnetic recording medium, such as a hard disk, an optical recording medium such as a compact disk (CD), and the like.

In this case, the program stored in the recording medium may be executed on hardware such as a computer or smart phone to perform each of the above-described embodiments. In particular, at least one of the functional blocks of the machine learning failure recovery apparatus 100 according to the present invention described above may be implemented by such a program or application.

In addition, the present invention is not limited to the specific embodiments described above, but may be implemented with various modifications and variations within the scope of the present invention. It is apparent that such variations and modifications are included in the present invention provided they come within the scope of the appended claims.

### INDUSTRIAL APPLICABILITY

As described above, according to the present invention, when a failure occurs in a machine learning workload, processing time can be shortened and resource usage can be minimized when machine learning is resumed later.

This provides a kind of session recovery function in case of machine learning model learning workload failure, which also has the effect of ensuring that the workload is not interrupted due to failures during machine learning model training.

1. A control method of machine learning failure recovery apparatus, the control method comprising:
(a) performing machine learning with learning data as an input, wherein the machine learning includes matching a learning data location where a learning has been completed with an intermediate storage model whenever a preset backup time arrives and storing a result of the matching;
(b) determining whether a failure occurs during the machine learning in step (a);
(c) extracting the intermediate storage model closest to a point in time when the failure occurred and a position of the learning data matched with the corresponding intermediate storage model when it is determined that the failure occurred in step (b); and
(d) resuming machine learning based on the intermediate storage model extracted in step (c) and the location of the learning data.

2. A machine learning failure recovery apparatus comprising:
a learning progress unit that performs machine learning using learning data as an input, wherein the machine learning includes matching an intermediate storage model with the location of the learning data that has been learned whenever a preset backup time arrives and storing a result of the matching;
a determination unit that determines whether a failure occurs during machine learning by the learning progress unit; and
an extraction unit for extracting the intermediate storage model closest to a point in time when the failure occurs and a location of learning data matched with the corresponding intermediate storage model when the determination unit determines that a failure occurs,
wherein the learning progress unit resumes machine learning based on the intermediate storage model and the location of the learning data extracted by the extraction unit.

3. The machine learning failure recovery apparatus of claim 2,
wherein the learning progress unit matches the intermediate storage model with the location of the learning data at a preset backup time interval and stores a result of the matching, and
further comprising a backup time adjustment unit that changes a size of the backup time interval based on at least one of a type of learning data, an amount of remaining learning data, and a type and shape of a machine learning model.

4. The machine learning failure recovery apparatus of claim 2,
wherein the learning progress unit matches the intermediate storage model with the location of the learning data at a preset backup time interval and stores a result of the matching, and
further comprising a backup time adjustment unit that dynamically changes a size of the backup time interval based on a machine learning elapsed time point at which an error occurred during machine learning by the learning progress unit.

5. The machine learning failure recovery apparatus of claim 2,
wherein the learning progress unit matches the intermediate storage model with the location of the learning data at a preset backup time interval and stores a result of the matching, and
further comprising a backup time adjustment unit that dynamically changes a size of the backup time interval based on a time interval in which a failure occurs during machine learning by the learning progress unit.

6. The machine learning failure recovery apparatus of claim 3,
wherein the learning progress unit matches the intermediate storage model with the location of the learning data at a preset backup time interval and stores a result of the matching, and
further comprising a backup time adjustment unit that dynamically changes a size of the backup time interval based on the type and cause of the identified failure after confirming the type and cause of the failure through log records, when a failure occurs during machine learning by the learning progress unit.
